(19) United States
(12) Patent Application Publication
(10) Pub. No.: US 2022/0252841 A1
(43) Pub. Date: Aug. 11, 2022

(54) Lens Assembly

(71) Applicants: Sintai Optical (Shenzhen) Co., Ltd., ShenZhen City (CN); Asia Optical Co., Inc., Taichung (TW)

(72) Inventors: Jian-Wei LEE, Taichung (TW); Chia-Hung SUN, Taichung (TW); Jia-Sin CHEN, Taichung (TW)

(21) Appl. No.: 17/571,613

(22) Filed: Jan. 10, 2022

(30) Foreign Application Priority Data
Feb. 8, 2021 (CN) 202110170318.4

(51) Int. Cl. G02B 13/00; G02B 9/62

(52) U.S. Cl. CPC G02B 13/0045; G02B 9/62

(57) ABSTRACT

A lens assembly includes a first lens, a second lens, a third lens, a fourth lens, a fifth lens, and a sixth lens. The first lens is with positive refractive power and includes a convex surface facing an object side. The second lens is with negative refractive power. The third lens is a biconvex lens with positive refractive power and includes a convex surface facing the object side and another convex surface facing an image side. The fourth lens is with negative refractive power. The fifth lens is with positive refractive power. The sixth lens is with positive refractive power and includes a convex surface facing the image side. The first lens, the second lens, the third lens, the fourth lens, the fifth lens, and the sixth lens are arranged in order from the object side to the image side along an optical axis.

### BACKGROUND OF THE INVENTION

### Field of the Invention

The invention relates to a lens assembly.

### Description of the Related Art

The current development trend of a lens assembly is toward miniaturization and high resolution. Additionally, the lens assembly is developed to resist environmental temperature change in accordance with different application requirements. However, the known lens assembly can't satisfy such requirements. Therefore, the lens assembly needs a new structure in order to meet the requirements of miniaturization, high resolution, and resisted environmental temperature change at the same time.

### BRIEF SUMMARY OF THE INVENTION

The invention provides a lens assembly to solve the above problems. The lens assembly of the invention is provided with characteristics of a shortened total lens length, a decreased F-number, an increased resolution, a resisted environmental temperature change, and still has a good optical performance.

The lens assembly in accordance with an exemplary embodiment of the invention includes a first lens, a second lens, a third lens, a fourth lens, a fifth lens, and a sixth lens. The first lens is with positive refractive power and includes a convex surface facing an object side. The second lens is with negative refractive power. The third lens is a biconvex lens with positive refractive power and includes a convex surface facing the object side and another convex surface facing an image side. The fourth lens is with negative refractive power. The fifth lens is with positive refractive power. The sixth lens is with positive refractive power and includes a convex surface facing the image side. The first lens, the second lens, the third lens, the fourth lens, the fifth lens, and the sixth lens are arranged in order from the object side to the image side along an optical axis. The lens assembly satisfies: 2.5<TTL/f<4.75; wherein TTL is an interval from an object side surface of the first lens to an image plane along the optical axis and f is an effective focal length of the lens assembly.

In another exemplary embodiment, the second lens includes a concave surface facing the image side, the fourth lens is a biconcave lens and includes a concave surface facing the object side and another concave surface facing the image side, and the fifth lens is a biconvex lens and includes a convex surface facing the object side and another convex surface facing the image side.

In yet another exemplary embodiment, the lens assembly further includes a seventh lens disposed between the sixth lens and the image side, wherein the first lens is a meniscus lens and further includes a concave surface facing the image side, and the seventh lens is a biconcave lens with negative refractive power and includes a concave surface facing the object side and another concave surface facing the image side.

In another exemplary embodiment, the second lens is a meniscus lens and further includes a convex surface facing the object side, and the sixth lens is a biconvex lens and further includes another convex surface facing the object side.

In yet another exemplary embodiment, the lens assembly satisfies: 3<TTL/BFL<6.8; −9.3<(R11+R12)/(R11−R12)<−0.2; 2<|f45/f|<6.5; −1<f4/f5<0; 20<Vd5−Vd4<40; −7<R32/R31<−0.2; wherein TTL is an interval from the object side surface of the first lens to the image plane along the optical axis, BFL is an interval from an image side surface of the lens closest to the image side to the image plane along the optical axis, R11 is a radius of curvature of the object side surface of the first lens, R12 is a radius of curvature of an image side surface of the first lens, f45 is an effective focal length of a combination of the fourth lens and the fifth lens, f is an effective focal length of the lens assembly, f4 is an effective focal length of the fourth lens, f5 is an effective focal length of the fifth lens, Vd4 is an Abbe number of the fourth lens, Vd5 is an Abbe number of the fifth lens, R31 is a radius of curvature of an object side surface of the third lens, and R32 is a radius of curvature of an image side surface of the third lens.

In another exemplary embodiment, the lens assembly further includes an eighth lens disposed between the seventh lens and the image side, wherein the sixth lens is a meniscus lens and further includes a concave surface facing the object side, and the eighth lens is a meniscus lens with positive refractive power and includes a convex surface facing the object side and a concave surface facing the image side.

In yet another exemplary embodiment, the lens assembly satisfies: 0.25<Nd6−Nd7<0.33; wherein Nd6 is an index of refraction of the sixth lens and Nd7 is an index of refraction of the seventh lens.

In another exemplary embodiment, the lens assembly satisfies: 1.0<Vd7/Vd6<1.5; wherein Vd6 is an Abbe number of the sixth lens and Vd7 is an Abbe number of the seventh lens.

In yet another exemplary embodiment, the first lens is a biconvex lens and further includes another convex surface facing the image side, and the sixth lens is a biconvex lens and further includes another convex surface facing the object side.

In another exemplary embodiment, the fourth lens and the fifth lens are cemented, and the sixth lens is an aspheric lens.

In yet another exemplary embodiment, the lens assembly further includes a stop disposed between the second lens and the fourth lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a lens assembly in accordance with a first embodiment of the invention;

FIG. 2A, FIG. 2B, FIG. 2C, and FIG. 2D depict a field curvature diagram, a distortion diagram, a spot diagram, and a modulation transfer function diagram of the lens assembly in accordance with the first embodiment of the invention, respectively;

FIG. 3 is a lens layout and optical path diagram of a lens assembly in accordance with a second embodiment of the invention;

FIG. 4 is a lens layout and optical path diagram of a lens assembly in accordance with a third embodiment of the invention;

FIG. 5A, FIG. 5B, FIG. 5C, and FIG. 5D depict a field curvature diagram, a distortion diagram, a spot diagram, and a modulation transfer function diagram of the lens assembly in accordance with the third embodiment of the invention, respectively;

FIG. 6 is a lens layout diagram of a lens assembly in accordance with a fourth embodiment of the invention;

FIG. 7 is a lens layout diagram of a lens assembly in accordance with a fifth embodiment of the invention;

FIG. 8 is a lens layout diagram of a lens assembly in accordance with a sixth embodiment of the invention;

FIG. 9 is a lens layout diagram of a lens assembly in accordance with a seventh embodiment of the invention;

FIG. 10A, FIG. 10B, and FIG. 10C depict a field curvature diagram, a distortion diagram, and a modulation transfer function diagram of the lens assembly in accordance with the seventh embodiment of the invention, respectively;

FIG. 11 is a lens layout diagram of a lens assembly in accordance with an eighth embodiment of the invention; and

FIG. 12A, FIG. 12B, and FIG. 12C depict a field curvature diagram, a distortion diagram, and a modulation transfer function diagram of the lens assembly in accordance with the eighth embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens assembly including a first lens, a second lens, a third lens, a fourth lens, a fifth lens, and a sixth lens. The first lens is with positive refractive power and includes a convex surface facing an object side. The second lens is with negative refractive power. The third lens is a biconvex lens with positive refractive power and includes a convex surface facing the object side and another convex surface facing an image side. The fourth lens is with negative refractive power. The fifth lens is with positive refractive power. The sixth lens is with positive refractive power and includes a convex surface facing the image side. The first lens, the second lens, the third lens, the fourth lens, the fifth lens, and the sixth lens are arranged in order from the object side to the image side along an optical axis. The lens assembly satisfies: 2.5<TTL/f<4.75; wherein TTL is an interval from an object side surface of the first lens to an image plane along the optical axis and f is an effective focal length of the lens assembly.

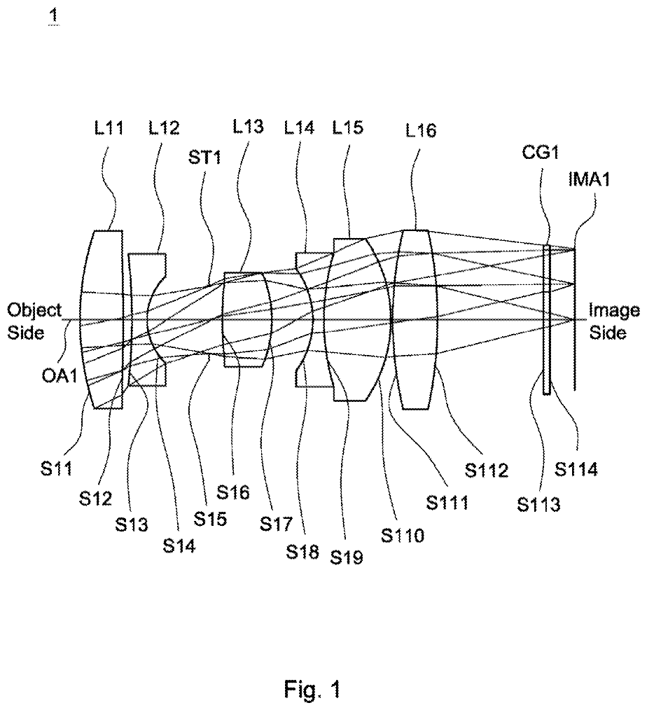

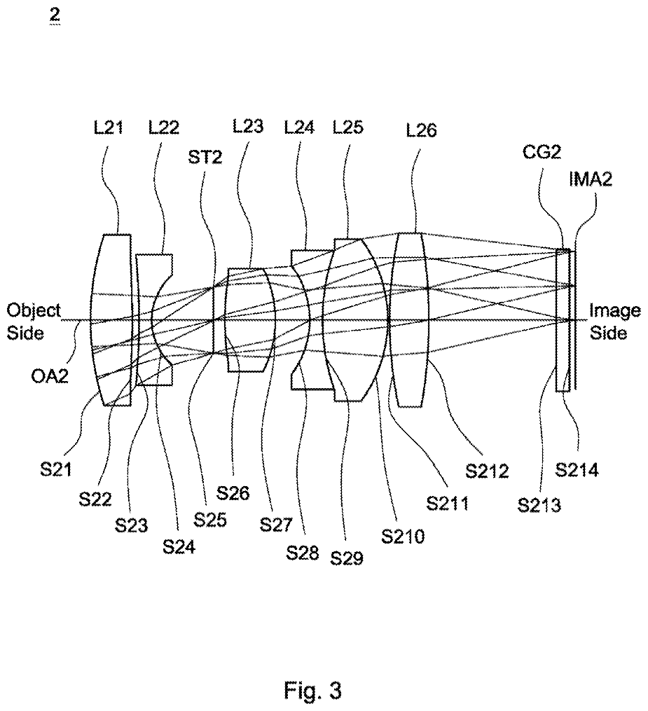

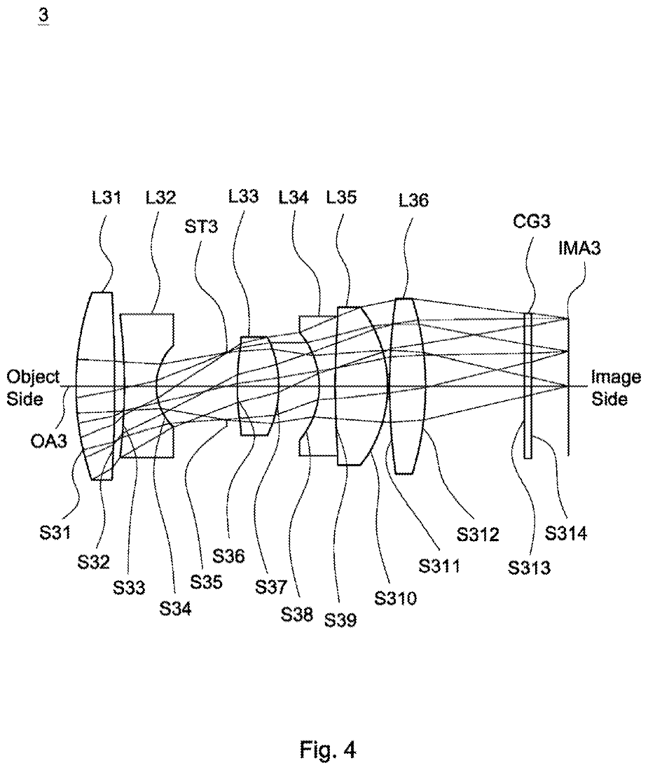

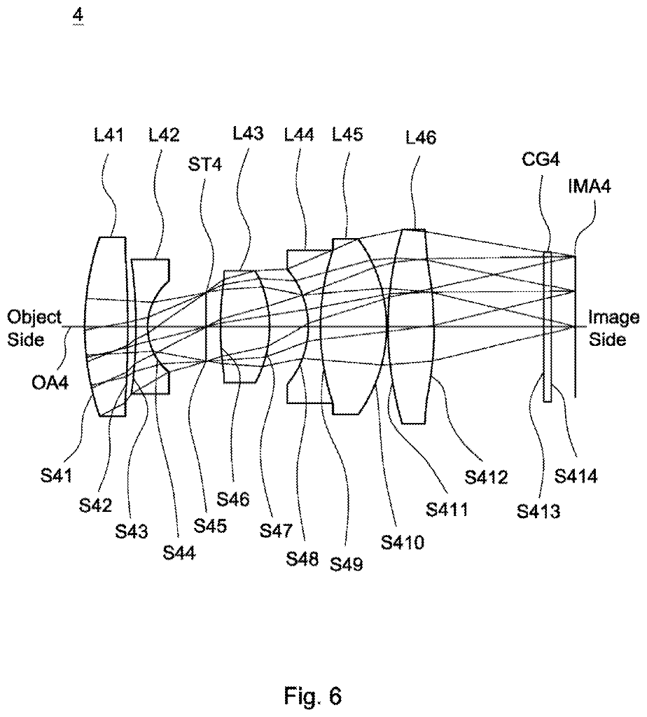

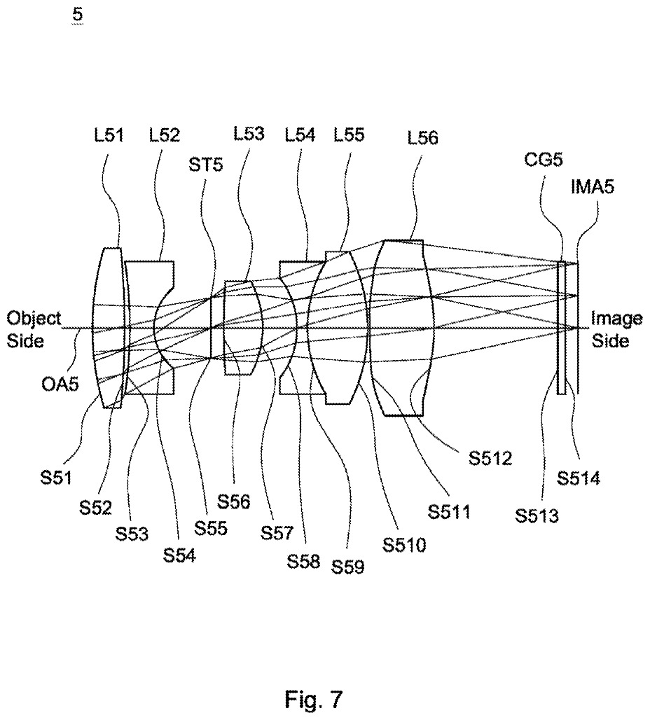

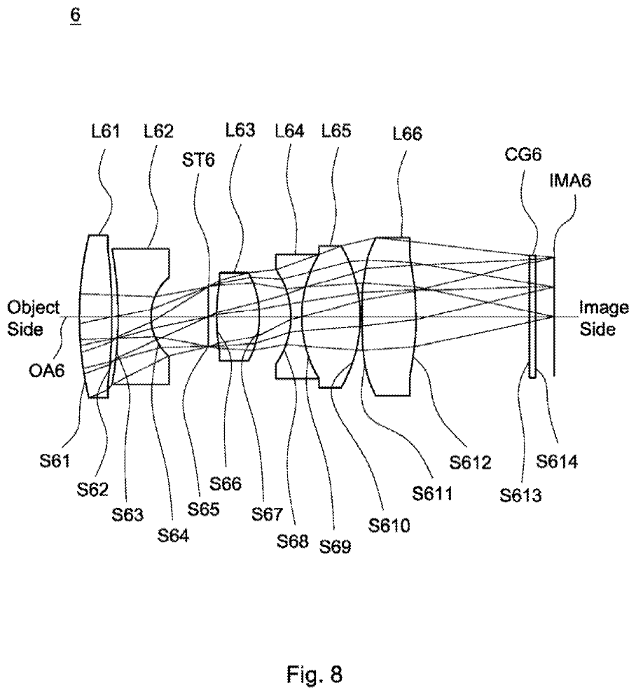

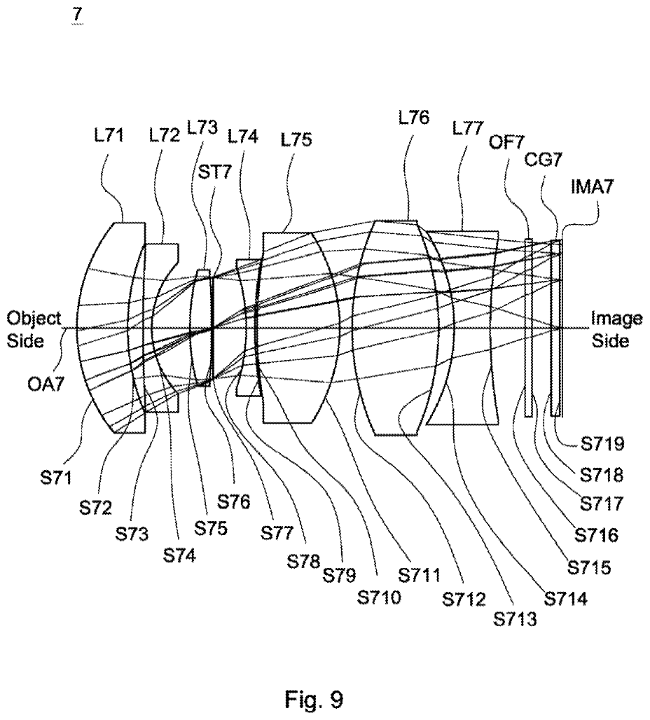

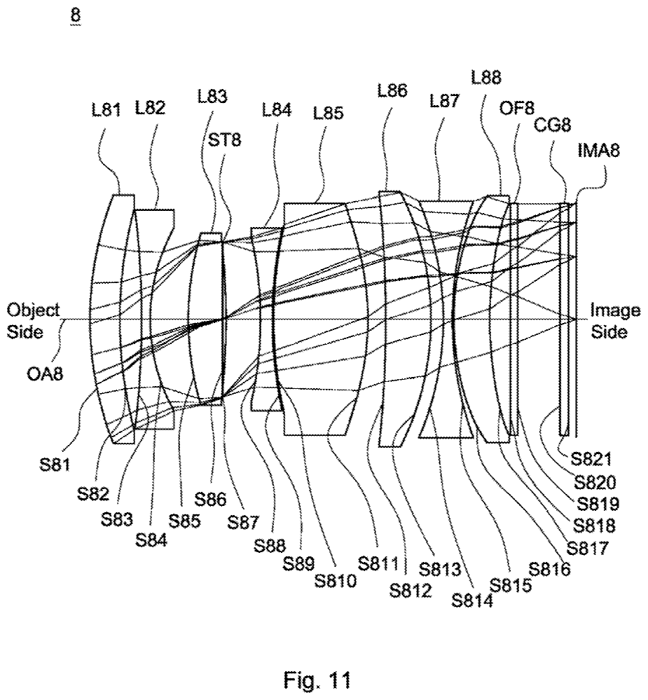

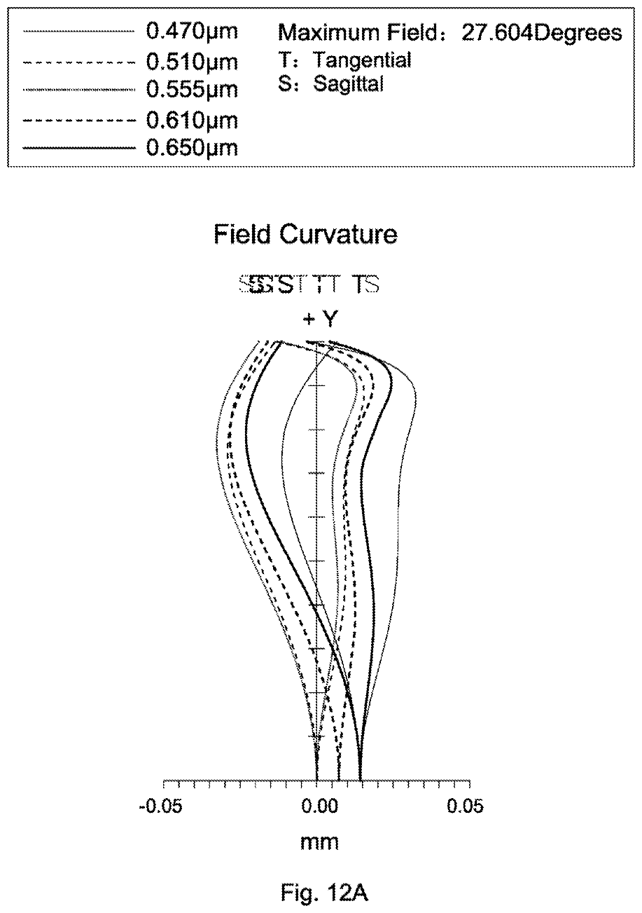

Referring to Table 1, Table 2, Table 4, Table 5, Table 7, Table 8, Table 10, Table 11, Table 13, Table 14, Table 16, Table 17, Table 19, Table 21, and Table 22, wherein Table 1, Table 4, Table 7, Table 10, Table 13, Table 16, Table 19, and Table 21 show optical specification in accordance with a first, second, third, fourth, fifth, sixth, seventh, and eighth embodiments of the invention, respectively and Table 2, Table 5, Table 8, Table 11, Table 14, Table 17, and Table 22 show aspheric coefficients of each aspheric lens in Table 1, Table 4, Table 7, Table 10, Table 13, Table 16, and Table 21, respectively. FIG. 1, FIG. 3, FIG. 4, FIG. 6, FIG. 7, FIG. 8, FIG. 9, and FIG. 11 are lens layout and optical path diagrams of the lens assemblies in accordance with the first, second, third, fourth, fifth, sixth, seventh, and eighth embodiments of the invention, respectively.

The first lenses L11, L21, L31, L41, L51, L61, L71, L81 are with positive refractive power and made of glass material, wherein the object side surfaces S11, S21, S31, S41, S51, S61, S71, S81 are convex surfaces and both of the object side surfaces S11, S21, S31, S41, S51, S61, S71, S81 and image side object side surfaces S12, S22, S32, S42, S52, S62, S72, S82 are spherical surfaces.

The second lenses L12, L22, L32, L42, L52, L62, L72, L82 are with negative refractive power and made of glass material, wherein the image side surfaces S14, S24, S34, S44, S54, S64, S74, S84 are concave surfaces and both of the object side surfaces S13, S23, S33, S43, S53, S63, S73, S83 and image side object side surfaces S14, S24, S34, S44, S54, S64, S74, S84 are spherical surfaces.

The third lenses L13, L23, L33, L43, L53, L63, L73, L83 are biconvex lenses with positive refractive power and made of glass material, wherein the object side surfaces S16, S26, S36, S46, S56, S66, S75, S85 are convex surfaces, the image side surfaces S17, S27, S37, S47, S57, S67, S76, S86 are convex surfaces and both of the object side surfaces S16, S26, S36, S46, S56, S66, S75, S85 and image side surfaces S17, S27, S37, S47, S57, S67, S76, S86 are spherical surfaces.

The fourth lenses L14, L24, L34, L44, L54, L64, L74, L84 are biconcave lenses with negative refractive power and made of glass material, wherein the object side surfaces S18, S28, S38, S48, S58, S68, S78, S88 are concave surfaces, the image side surfaces S19, S29, S39, S49, S59, S69, S79, S89 are concave surfaces, and both of the object side surfaces S18, S28, S38, S48, S58, S68, S78, S88 and image side surfaces S19, S29, S39, S49, S59, S69, S79, S89 are spherical surfaces.

The fifth lenses L15, L25, L35, L45, L55, L65, L75, L85 are biconvex lenses with positive refractive power and made of glass material, wherein the object side surfaces S19, S29, S39, S49, S59, S69, S710, S810 are convex surfaces and the image side surfaces S110, S210, S310, S410, S510, S610, S711, S811 are convex surfaces.

The sixth lenses L16, L26, L36, L46, L56, L66, L76, L86 are with positive refractive power and made of glass material, wherein the image side surfaces S112, S212, S312, S412, S512, S612, S713, S813 are convex surfaces.

In addition, the lens assemblies 1, 2, 3, 4, 5, 6 satisfy at least one of the following conditions (1)-(7) and the lens assemblies 7,8 satisfy at least one of the following conditions (1)-(9):

2.50<TTL/f<4.75; (1)

3<TTL/BFL<6.8; (2)

−9.3<(R11+R12)/(R11−R12)<−0.2; (3)

2<|f45/f<6.5; (4)

−1<f4/f5<0; (5)

20<Vd5−Vd4<40; (6)

−7<R32/R31<−0.2; (7)

1.0<Vd7/Vd6<1.5; (8)

0.25<Nd6−Nd7<0.33; (9)

wherein TTL is an interval from the object side surfaces S11, S21, S31, S41, S51, S61, S71, S81 of the first lenses L11, L21, L31, L41, L51, L61, L71, L81 to the image planes IMA1, IMA2, IMA3, IMA4, IMA5, IMA6, IMA7, IMA8 along the optical axes OA1, OA2, OA3, OA4, OA5, OA6, OA7, OA8 for the first to eighth embodiments, respectively, BFL is an interval from the image side surfaces S112, S212, S312, S412, S512, S612, S715, S817 of the lenses L16, L26, L36, L46, L56, L66, L77, L88 closest to the image side to the image planes IMA1, IMA2, IMA3, IMA4, IMA5, IMA6, IMA7, IMA8 along the optical axes OA1, OA2, OA3, OA4, OAS, OA6, OA7, OA8 for the first to eighth embodiments, respectively, f is an effective focal length of the lens assemblies 1, 2, 3, 4, 5, 6, 7, 8 for the first to eighth embodiments, f4 is an effective focal length of the fourth lenses L14, L24, L34, L44, L54, L64, L74, L84 for the first to eighth embodiments, f5 is an effective focal length of the fifth lenses L15, L25, L35, L45, L55, L65, L75, L85 for the first to eighth embodiments, f45 is an effective focal length of the combination of the fourth lenses L14, L24, L34, L44, L54, L64, L74, L84 and the fifth lenses L15, L25, L35, L45, L55, L65, L75, L85 for the first to eighth embodiments, R11 is a radius of curvature of the object side surfaces S11, S21, S31, S41, S51, S61, S71, S81 of the first lenses L11, L21, L31, L41, L51, L61, L71, L81 for the first to eighth embodiments, R12 is a radius of curvature of the image side surfaces S12, S22, S32, S42, S52, S62, S72, S82 of the first lenses L11, L21, L31, L41, L51, L61, L71, L81 for the first to eighth embodiments, R31 is a radius of curvature of the object side surfaces S16, S26, S36, S46, S56, S66, S75, S85 of the third lenses L13, L23, L33, L43, L53, L63, L73, L83 for the first to eighth embodiments, R32 is a radius of curvature of the image side surfaces S17, S27, S37, S47, S57, S67, S76, S86 of the third lenses L13, L23, L33, L43, L53, L63, L73, L83 for the first to eighth embodiments, Vd4 is an Abbe number of the fourth lenses L14, L24, L34, L44, L54, L64, L74, L84 for the first to eighth embodiments, Vd5 is an Abbe number of the fifth lenses L15, L25, L35, L45, L55, L65, L75, L85 for the first to eighth embodiments, Vd6 is an Abbe number of the sixth lenses L76, L86 for the seventh to eighth embodiments, Vd7 is an Abbe number of the seventh lenses L77, L87 for the seventh to eighth embodiments, Nd6 is an index of refraction of the sixth lenses L76, L86 for the seventh to eighth embodiments, and Nd7 is an index of refraction of the seventh lenses L77, L87 for the seventh to eighth embodiments. With the lens assemblies 1, 2, 3, 4, 5, 6, 7, 8 satisfying at least one of the above conditions (1)-(9), the total lens length can be effectively shortened, the resolution can be effectively increased, the environmental temperature change can be effectively resisted, the aberration can be effectively corrected, and the chromatic aberration can be effectively corrected.

When the condition (1): 2.50<TTL/f<4.75 is satisfied, the total lens length can be effectively decreased.

When the condition (2): 3<TTL/BFL<6.8 is satisfied, the back focal length can be effectively increased to facilitate the assembly of the lens assembly, and can reserve space to install additional reflective element or other application element.

When the condition (3): −9.3<(R11+R12)/(R11−R12)<−0.2 is satisfied, the first lens can be ensured to have positive refractive power and is a biconvex lens.

When the condition (4): 2<|f45/f<6.5 is satisfied, the chromatic aberration can be effectively decreased and the image quality can be greatly improved.

When the condition (5): −1<f4/f5<0 is satisfied, the processing sensitivity can be effectively decreased and the image quality can be improved.

When the condition (6): 20<Vd5−Vd4<40 is satisfied, the chromatic aberration can be effectively decreased and the image quality can be improved.

When the condition (7): −7<R32/R31<−0.2 is satisfied, the sensitivity of the third lens can be effectively decreased and the image quality can be improved.

When the condition (8): 1.0<Vd7/Vd6<1.5 is satisfied, the chromatic aberration can be effectively decreased and the image quality can be improved.

When the condition (9): 0.25<Nd6−Nd7<0.33 is satisfied, the image quality can be effectively improved.

The optical path can be effectively adjusted so that it is not easy to have a big turn when the first lens has positive refractive power and is a biconvex lens.

The spherical aberration caused by the first lens being a biconvex lens can be effectively decreased when the second lens has negative refractive power and is a biconcave lens, and the distortion can be effectively decreased when the first lens has positive refractive power and the second lens has negative refractive power.

The total lens length can be effectively decreased when the third lens is a biconvex lens with positive refractive power.

The axial and lateral chromatic aberration can be effectively decreased and the resolution can be effectively improved when the fourth lens and the fifth lens are cemented.

The incident angle of chief ray can be adjusted significantly and the back focal length can be effectively increased thereby facilitates the assembly of the lens assembly when the sixth lens is an aspheric lens with positive refractive power.

A detailed description of a lens assembly in accordance with a first embodiment of the invention is as follows. Referring to FIG. 1, the lens assembly 1 includes a first lens L11, a second lens L12, a stop ST1, a third lens L13, a fourth lens L14, a fifth lens L15, a sixth lens L16, and a cover glass CG1, all of which are arranged in order from an object side to an image side along an optical axis OA1. In operation, the light from the object side is imaged on an image plane IMA1.

According to paragraphs [0030]-[0037], wherein: the first lens L11 is a biconvex lens, wherein the image side surface S12 is a convex surface; the second lens L12 is a biconcave lens, wherein the object side surface S13 is a concave surface; both of the object side surface S19 and image side surface S110 of the fifth lens L15 are spherical surfaces; the sixth lens L16 is a biconvex lens, wherein the object side surface S111 is a convex surface, and both of the object side surface S111 and image side surface S112 are aspheric surfaces; the fourth lens L14 and the fifth lens L15 are cemented; and both of the object side surface S113 and image side surface S114 of the cover glass CG1 are plane surfaces.

With the above design of the lenses, stop ST1, and at least one of the conditions (1)-(7) satisfied, the lens assembly 1 can have an effective shortened total lens length, an effective increased resolution, an effective resisted environmental temperature change, an effective corrected aberration, and an effective corrected chromatic aberration.

Table 1 shows the optical specification of the lens assembly 1 in FIG. 1.

TABLE 1
Effective Focal Length = 9.52 mm
F-number = 2.20 Total Lens
Length = 40.00 mm
Field of View = 61.98 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S11 | 21.41 | 3.50 | 1.81 | 25.5 | 23.36 | L11 |
| S12 | −115.10 | 0.67 | | | | |
| S13 | −41.39 | 1.20 | 1.52 | 64.2 | −7.97 | L12 |
| S14 | 4.55 | 4.97 | | | | |
| S15 | ∞ | 1.07 | | | | ST1 |
| S16 | 21.68 | 4.06 | 1.68 | 55.6 | 9.59 | L13 |
| S17 | −8.40 | 3.28 | | | | |
| S18 | −6.55 | 0.92 | 1.85 | 23.8 | −5.78 | L14 |
| S19 | 18.25 | 5.36 | 1.77 | 49.6 | 9.56 | L15 |
| S110 | −10.53 | 0.15 | | | | |
| S111 | 33.01 | 3.61 | 1.81 | 41 | 17.38 | L16 |
| S112 | −22.32 | 10.53 | | | | |
| S113 | ∞ | 0.55 | 1.52 | 64.1 | | CG1 |
| S114 | ∞ | 0.14 | | | | |

The aspheric surface sag z of each aspheric lens in table 1 can be calculated by the following formula:

z=ch²/{1+[1−(k+1)c²h²]^{1/2}}+Ah⁴±Bh⁶+Ch⁸+Dh¹⁰+Eh¹²+Fh¹⁴+Gh¹⁶

where c is curvature, h is the vertical distance from the lens surface to the optical axis, k is conic constant and A, B, C, D, E, F, and G are aspheric coefficients.

In the first embodiment, the conic constant k and the aspheric coefficients A, B, C, D, E, F, G of each aspheric lens are shown in Table 2.

TABLE 2

| Surface | | A | B | C | |
|---|---|---|---|---|---|
| Number | k | E | F | G | D |
| S111 | 3.0492 | −2.1698E−05 | 2.0013E−06 | −3.6238E−08 | 2.7947E−10 |
| | | 8.2307E−12 | −1.0525E−13 | 3.5330E−17 | |
| S112 | −1.6829 | 7.8151E−05 | 7.1715E−07 | 1.6453E−08 | −4.7764E−10 |
| | | −2.7363E−12 | 3.6455E−13 | −3.8770E−15 | |

Table 3 shows the parameters and condition values for conditions (1)-(7) in accordance with the first embodiment of the invention. It can be seen from Table 3 that the lens assembly 1 of the first embodiment satisfies the conditions (1)-(7).

TABLE 3

| | | | | | |
|---|---|---|---|---|---|
| BFL | 11.22 mm | f45 | −42.12 mm | TTL/f | 4.20 |
| TTL/BFL | 3.57 | (R11 + R12)/ | −0.69 | \| f45/f \| | 4.43 |
| | | (R11 − R12) | | | |
| f4/f5 | −0.60 | Vd5 − Vd4 | 25.80 | R32/R31 | −0.39 |

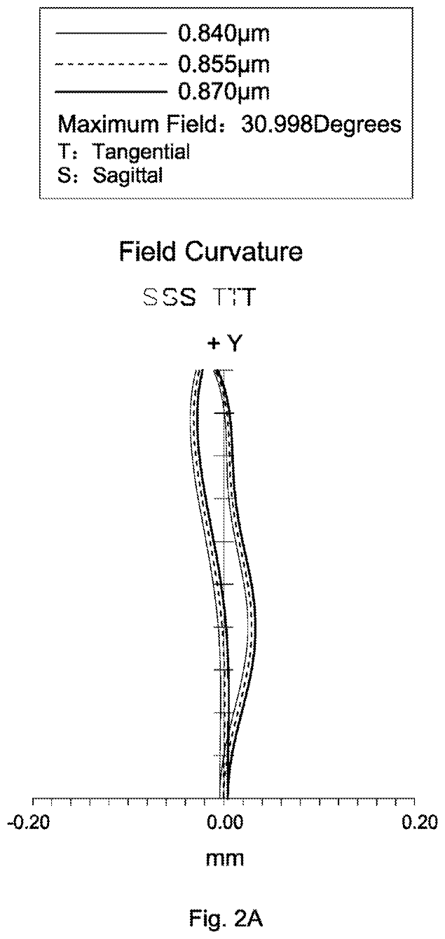

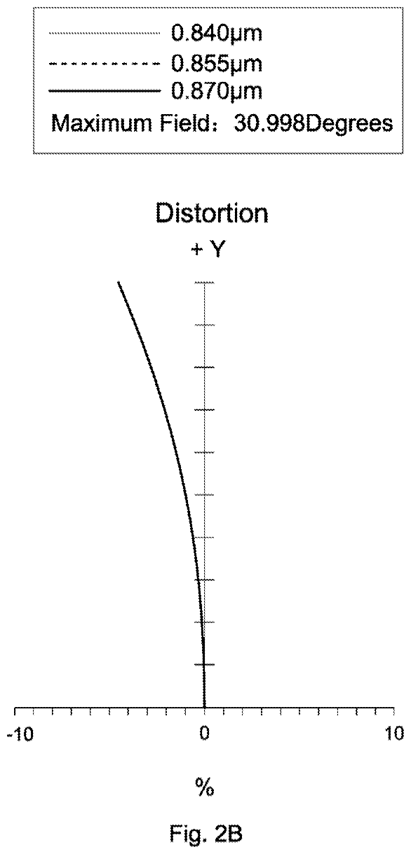

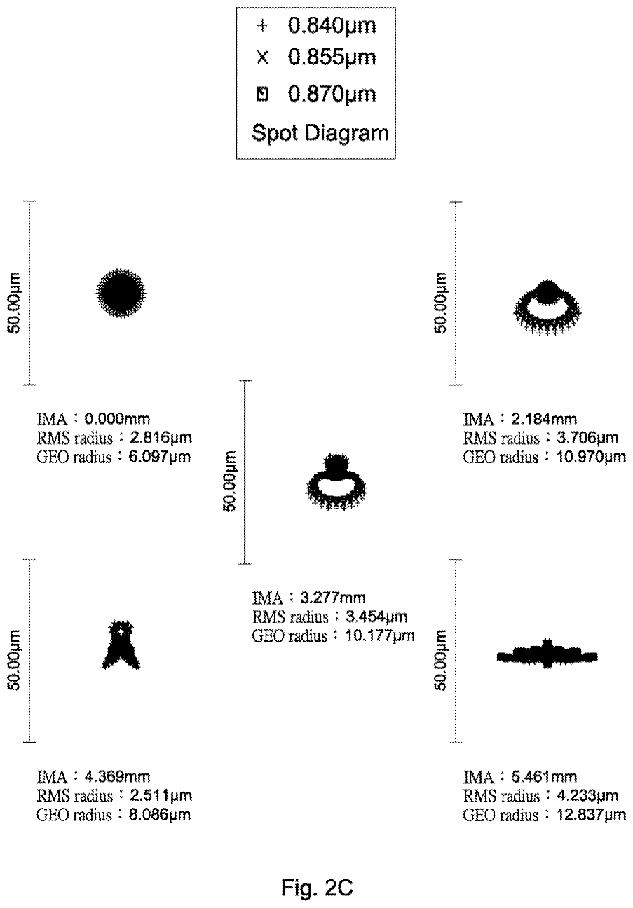

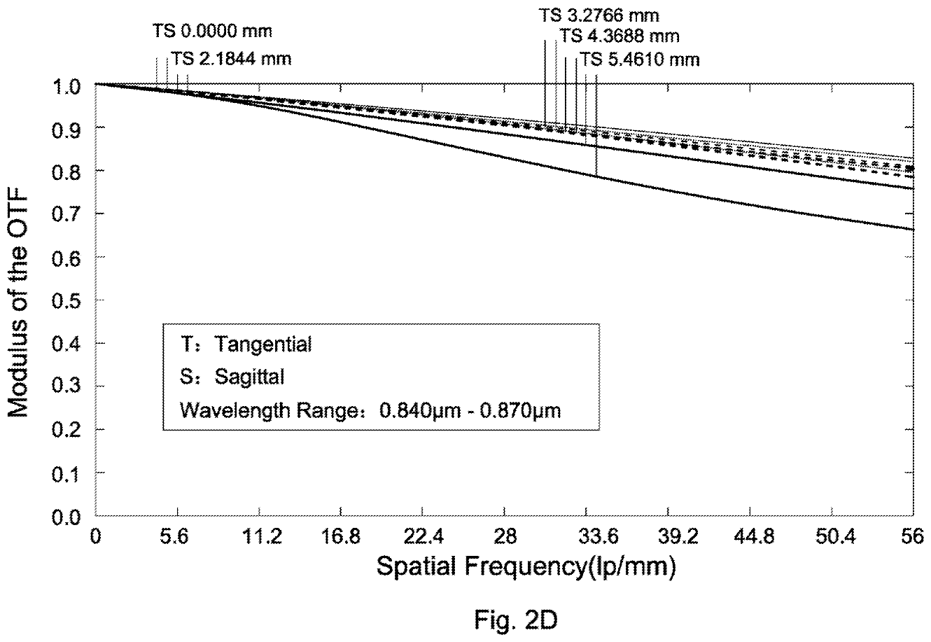

In addition, the lens assembly 1 of the first embodiment can meet the requirements of optical performance as seen in FIGS. 2A-2D. It can be seen from FIG. 2A that the field curvature of tangential direction and sagittal direction in the lens assembly 1 of the first embodiment ranges from −0.04 mm to 0.04 mm. It can be seen from FIG. 2B that the distortion in the lens assembly 1 of the first embodiment ranges from −5% to 0%. It can be seen from FIG. 2C that the root mean square spot radius is equal to 2.816 μm and geometrical spot radius is equal to 6.097 μm as image height is equal to 0.000 mm, the root mean square spot radius is equal to 3.706 μm and geometrical spot radius is equal to 10.970 μm as image height is equal to 2.184 mm, the root mean square spot radius is equal to 3.454 μm and geometrical spot radius is equal to 10.177 μm as image height is equal to 3.277 mm, the root mean square spot radius is equal to 2.511 μm and geometrical spot radius is equal to 8.086 μm as image height is equal to 4,369 mm, and the root mean square spot radius is equal to 4.233 μm and geometrical spot radius is equal to 12.837 μm as image height is equal to 5.461 mm for the lens assembly 1 of the first embodiment. It can be seen from FIG. 2D that the modulation transfer function of tangential direction and sagittal direction in the lens assembly 1 of the first embodiment ranges from 0.67 to 1.0. It is obvious that the field curvature and the distortion of the lens assembly 1 of the first embodiment can be corrected effectively, and the resolution of the lens assembly 1 of the first embodiment can meet the requirement. Therefore, the lens assembly 1 of the first embodiment is capable of good optical performance.

Referring to FIG. 3, the lens assembly 2 includes a first lens L21, a second lens L22, a stop ST2, a third lens L23, a fourth lens L24, a fifth lens L25, a sixth lens L26, and a cover glass CG2, all of which are arranged in order from an object side to an image side along an optical axis OA2. In operation, the light from the object side is imaged on an image plane IMA2.

According to paragraphs [0030]-[0037], wherein: the first lens L21 is a biconvex lens, wherein the image side surface S22 is a convex surface; the second lens L22 is a biconcave lens, wherein the object side surface S23 is a concave surface; both of the object side surface S29 and image side surface S210 of the fifth lens L25 are spherical surfaces; the sixth lens L26 is a biconvex lens, wherein the object side surface S211 is a convex surface, and both of the object side surface S211 and image side surface S212 are aspheric surfaces; the fourth lens L24 and the fifth lens L25 are cemented; and both of the object side surface S213 and image side surface S214 of the cover glass CG2 are plane surfaces.

With the above design of the lenses, stop ST2, and at least one of the conditions (1)-(7) satisfied, the lens assembly 2 can have an effective shortened total lens length, an effective increased resolution, an effective resisted environmental temperature change, an effective corrected aberration, and an effective corrected chromatic aberration.

Table 4 shows the optical specification of the lens assembly 2 in FIG. 3.

TABLE 4
Effective Focal Length = 9.94 mm
F-number = 2.30 Total Lens
Length = 40.00 mm
Field of View = 59.98 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S21 | 21.24 | 3.38 | 1.81 | 25.5 | 23.12 | L21 |
| S22 | −112.59 | 0.62 | | | | |
| S23 | −41.03 | 1.01 | 1.52 | 64.2 | −8.05 | L22 |
| S24 | 4.60 | 5.07 | | | | |
| S25 | ∞ | 0.95 | | | | ST2 |
| S26 | 20.66 | 4.20 | 1.68 | 55.6 | 9.46 | L23 |
| S27 | −8.36 | 2.81 | | | | |
| S28 | −6.72 | 1.08 | 1.85 | 23.8 | −5.7 | L24 |
| S29 | 16.46 | 5.37 | 1.77 | 49.6 | 9.13 | L25 |
| S210 | −10.29 | 0.15 | | | | |
| S211 | 36.00 | 3.21 | 1.81 | 41 | 20.89 | L26 |
| S212 | −29.19 | 10.531 | | | | |
| S213 | ∞ | 1.1 | 1.52 | 64.1 | | CG2 |
| S214 | ∞ | 0.5 | | | | |

The definition of aspheric surface sag z of each aspheric lens in table 4 is the same as that of in Table 1, and is not described here again.

In the second embodiment, the conic constant k and the aspheric coefficients A, B, C, D, E, F, G of each aspheric lens are shown in Table 5.

TABLE 5

| Surface | | A | B | C | |
|---|---|---|---|---|---|
| Number | k | E | F | G | D |
| S211 | 4.4258 | 1.5292E−05 | −5.3467E−08 | 5.5819E−09 | −1.7872E−10 |
| | | 0 | 0 | 0 | |
| S212 | −3.8346 | 9.8423E−05 | −3.4255E−07 | 1.5865E−08 | −2.7897E−10 |
| | | 0 | 0 | 0 | |

Table 6 shows the parameters and condition values for conditions (1)-(7) in accordance with the second embodiment of the invention. It can be seen from Table 5 that the lens assembly 2 of the second embodiment satisfies the conditions (1)-(7).

TABLE 6

| | | | | | |
|---|---|---|---|---|---|
| BFL | 12.13 mm | f45 | −54.01 mm | TTL/f | 4.02 |
| TTL/BFL | 3.30 | (R11 + R12)/ | −0.68 | \| f45/f \| | 5.43 |
| | | (R11 − R12) | | | |
| f4/f5 | −0.62 | Vd5 − Vd4 | 25.80 | R32/R31 | −0.40 |

In addition, the lens assembly 2 of the second embodiment can meet the requirements of optical performance, wherein the field curvature diagram, the distortion diagram, the spot diagram, and the modulation transfer function diagram are similar to those of the lens assembly 1 of the first embodiment, so that those figures are omitted.

Referring to FIG. 4, the lens assembly 3 includes a first lens L31, a second lens L32, a stop ST3, a third lens L33, a fourth lens L34, a fifth lens L35, a sixth lens L36, and a cover glass CG3, all of which are arranged in order from an object side to an image side along an optical axis OA3. In operation, the light from the object side is imaged on an image plane IMA3.

According to paragraphs [0030]-[0037], wherein: the first lens L31 is a biconvex lens, wherein the image side surface S32 is a convex surface; the second lens L32 is a biconcave lens, wherein the object side surface S33 is a concave surface; both of the object side surface S39 and image side surface S310 of the fifth lens L35 are spherical surfaces; the sixth lens L36 is a biconvex lens, wherein the object side surface S311 is a convex surface, and both of the object side surface S311 and image side surface S312 are aspheric surfaces; the fourth lens L34 and the fifth lens L35 are cemented; and both of the object side surface S313 and image side surface S314 of the cover glass CG3 are plane surfaces.

With the above design of the lenses, stop ST3, and at least one of the conditions (1)-(7) satisfied, the lens assembly 3 can have an effective shortened total lens length, an effective increased resolution, an effective resisted environmental temperature change, an effective corrected aberration, and an effective corrected chromatic aberration.

Table 7 shows the optical specification of the lens assembly 3 in FIG. 4.

TABLE 7
Effective Focal Length = 9.52 mm
F-number = 2.15 Total Lens
Length = 39.99 mm
Field of View = 60.02 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S31 | 21.94 | 3.16 | 1.81 | 25.5 | 23.97 | L31 |
| S32 | −119.96 | 0.81 | | | | |
| S33 | −45.96 | 2.56 | 1.52 | 64.2 | −8.03 | L32 |
| S34 | 4.58 | 5.76 | | | | |
| S35 | ∞ | 0.88 | | | | ST3 |
| S36 | 26.76 | 3.31 | 1.68 | 55.6 | 10.17 | L33 |
| S37 | −8.65 | 3.27 | | | | |
| S38 | −6.81 | 1.30 | 1.85 | 23.8 | −7.45 | L34 |
| S39 | 64.38 | 4.28 | 1.77 | 49.6 | 11.98 | L35 |
| S310 | −10.29 | 0.15 | | | | |
| S311 | 45.01 | 2.95 | 1.81 | 41 | 17.4 | L36 |
| S312 | −19.19 | 10.53 | | | | |
| S313 | ∞ | 0.5 | 1.52 | 64.1 | | CG3 |
| S314 | ∞ | 0.55 | | | | |

The definition of aspheric surface sag z of each aspheric lens in table 7 is the same as that of in Table 1, and is not described here again.

In the third embodiment, the conic constant k and the aspheric coefficients A, B, C, D, E, F, G of each aspheric lens are shown in Table 8.

TABLE 8

| Surface | | A | B | C | |
|---|---|---|---|---|---|
| Number | k | E | F | G | D |
| S311 | −2.2584 | −4.5167E−05 | 1.6797E−06 | −5.8487E−08 | 1.2506E−09 |
| | | −1.7826E−11 | 1.9229E−13 | −1.0650E−15 | |
| S312 | −1.6996 | 4.4510E−05 | −2.8055E−07 | 3.2515E−08 | −1.0479E−09 |
| | | 1.0423E−11 | 8.8425E−14 | −1.5030E−15 | |

Table 9 shows the parameters and condition values for conditions (1)-(7) in accordance with the third embodiment of the invention. It can be seen from Table 9 that the lens assembly 3 of the third embodiment satisfies the conditions (1)-(7).

TABLE 9

| | | | | | |
|---|---|---|---|---|---|
| BFL | 11.58 mm | f45 | −51.34 mm | TTL/f | 4.20 |
| TTL/BFL | 3.45 | (R11 + R12)/ | −0.69 | \| f45/f \| | 5.39 |
| | | (R11 − R12) | | | |
| f4/f5 | −0.62 | Vd5 − Vd4 | 25.80 | R32/R31 | −0.32 |

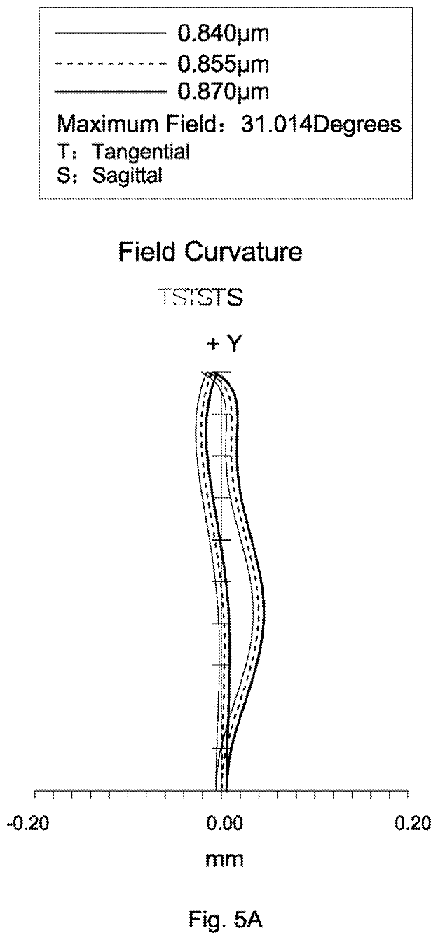

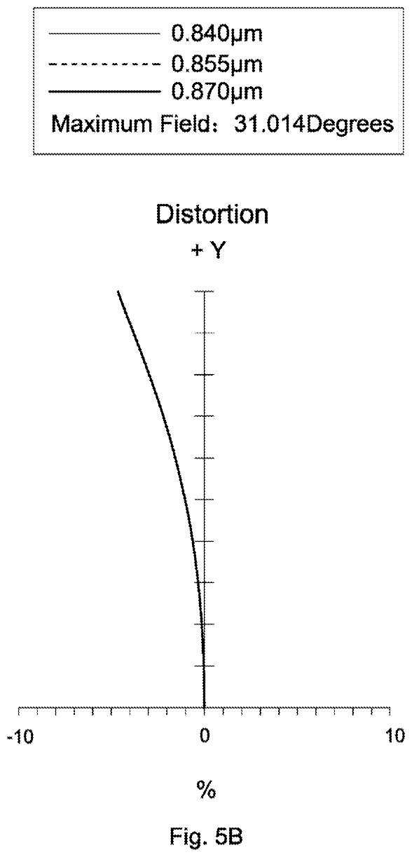

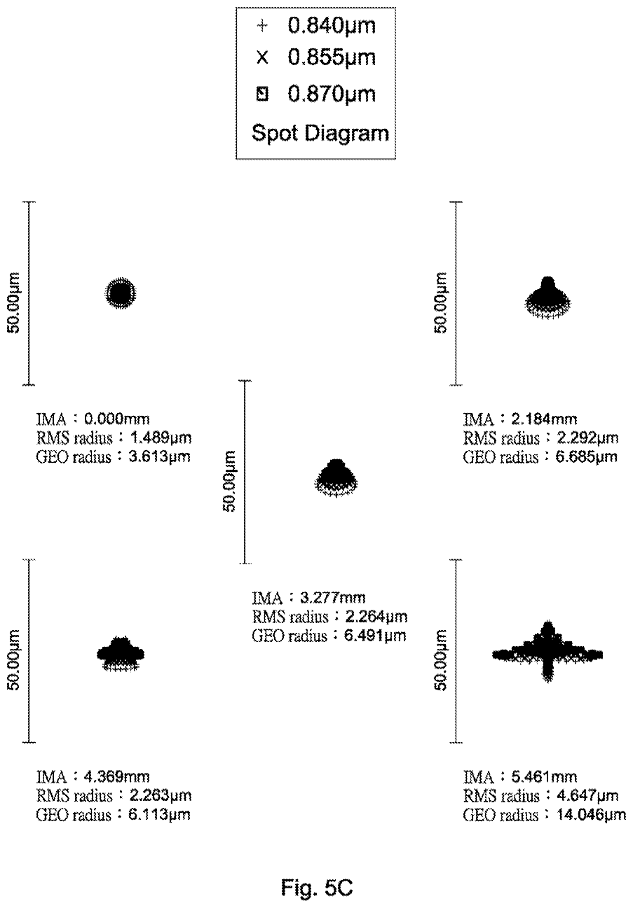

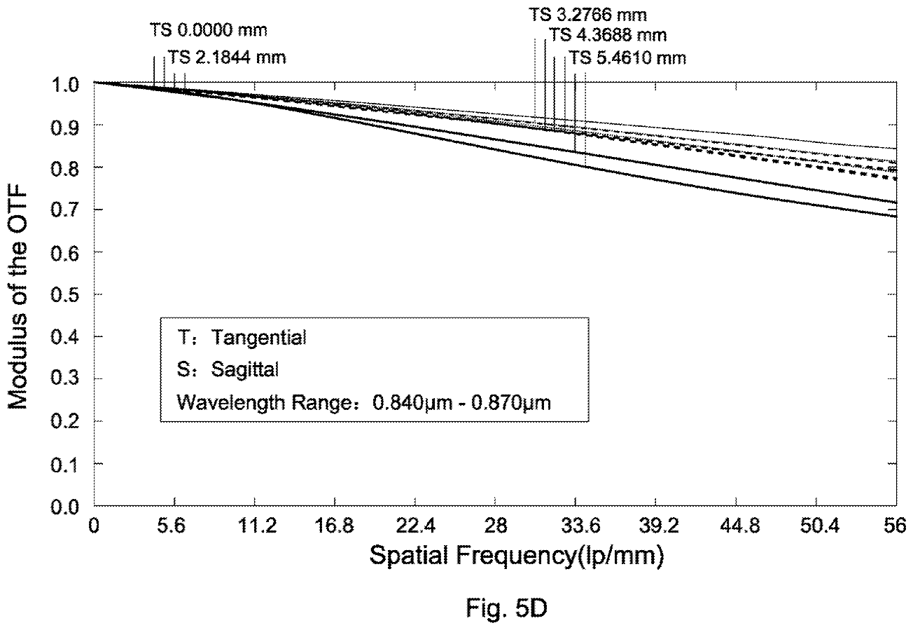

In addition, the lens assembly 3 of the third embodiment can meet the requirements of optical performance as seen in FIGS. 5A-5D. It can be seen from FIG. 5A that the field curvature of tangential direction and sagittal direction in the lens assembly 3 of the third embodiment ranges from −0.04 mm to 0.05 mm. It can be seen from FIG. 5B that the distortion in the lens assembly 3 of the third embodiment ranges from −5% to 0%. It can be seen from FIG. 5C that the root mean square spot radius is equal to 1.489 μm and geometrical spot radius is equal to 3.613 μm as image height is equal to 0.000 mm, the root mean square spot radius is equal to 2.292 μm and geometrical spot radius is equal to 6.685 μm as image height is equal to 2.184 mm, the root mean square spot radius is equal to 2.264 μm and geometrical spot radius is equal to 6.491 μm as image height is equal to 3.277 mm, the root mean square spot radius is equal to 2.263 μm and geometrical spot radius is equal to 6.113 μm as image height is equal to 4,369 mm, and the root mean square spot radius is equal to 4.647 μm and geometrical spot radius is equal to 14.046 μm as image height is equal to 5.461 mm for the lens assembly 3 of the third embodiment. It can be seen from FIG. 5D that the modulation transfer function of tangential direction and sagittal direction in the lens assembly 3 of the third embodiment ranges from 0.68 to 1.0. It is obvious that the field curvature and the distortion of the lens assembly 3 of the third embodiment can be corrected effectively, and the resolution of the lens assembly 3 of the third embodiment can meet the requirement. Therefore, the lens assembly 3 of the third embodiment is capable of good optical performance.

Referring to FIG. 6, the lens assembly 4 includes a first lens L41, a second lens L42, a stop ST4, a third lens L43, a fourth lens L44, a fifth lens L45, a sixth lens L46, and a cover glass CG4, all of which are arranged in order from an object side to an image side along an optical axis OA4. In operation, the light from the object side is imaged on an image plane IMA4.

According to paragraphs [0030]-[0037], wherein: the first lens L41 is a biconvex lens, wherein the image side surface S42 is a convex surface; the second lens L42 is a biconcave lens, wherein the object side surface S43 is a concave surface; both of the object side surface S49 and image side surface S410 of the fifth lens L45 are spherical surfaces; the sixth lens L46 is a biconvex lens, wherein the object side surface S411 is a convex surface, and both of the object side surface S411 and image side surface S412 are aspheric surfaces; the fourth lens L44 and the fifth lens L45 are cemented; and both of the object side surface S413 and image side surface S414 of the cover glass CG4 are plane surfaces.

With the above design of the lenses, stop ST4, and at least one of the conditions (1)-(7) satisfied, the lens assembly 4 can have an effective shortened total lens length, an effective increased resolution, an effective resisted environmental temperature change, an effective corrected aberration, and an effective corrected chromatic aberration.

Table 10 shows the optical specification of the lens assembly 4 in FIG. 6.

TABLE 10
Effective Focal Length = 9.71 mm
F-number = 2.20 Total Lens
Length = 39.99 mm
Field of View = 56.30 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S41 | 20.67 | 3.499 | 1.81 | 25.5 | 22.28 | L41 |
| S42 | −101.94 | 0.668 | | | | |
| S43 | −37.15 | 0.981 | 1.52 | 64.2 | −7.89 | L42 |
| S44 | 4.55 | 4.722 | | | | |
| S45 | ∞ | 1.189 | | | | ST4 |
| S46 | 23.71 | 4.018 | 1.68 | 55.6 | 9.71 | L43 |
| S47 | −8.32 | 3.146 | | | | |
| S48 | −6.81 | 0.992 | 1.85 | 23.8 | −5.92 | L44 |
| S49 | 17.98 | 5.423 | 1.77 | 49.6 | 9.68 | L45 |
| S410 | −10.81 | 0.149 | | | | |
| S411 | 33.36 | 3.673 | 1.81 | 41 | 17.98 | L46 |
| S412 | −23.47 | 10.531 | | | | |
| S413 | ∞ | 0.550 | 1.52 | 64.1 | | CG4 |
| S414 | ∞ | 0.453 | | | | |

The definition of aspheric surface sag z of each aspheric lens in table 10 is the same as that of in Table 1, and is not described here again.

In the fourth embodiment, the conic constant k and the aspheric coefficients A, B, C, D, E, F, G of each aspheric lens are shown in Table 11.

TABLE 11

| Surface | | A | B | C | |
|---|---|---|---|---|---|
| Number | k | E | F | G | D |
| S411 | 5.2248 | −5.6552E−06 | 1.6970E−06 | −3.1635E−08 | 2.8639E−10 |
| | | 7.2923E−12 | −1.3366E−13 | 4.4110E−16 | |
| S412 | −2.9511 | 8.5097E−05 | 6.3163E−07 | 1.2782E−08 | −2.5938E−10 |
| | | −3.5322E−12 | 2.6380E−13 | −2.7980E−15 | |

Table 12 shows the parameters and condition values for conditions (1)-(7) in accordance with the fourth embodiment of the invention. It can be seen from Table 12 that the lens assembly 4 of the fourth embodiment satisfies the conditions (1)-(7).

TABLE 12

| | | | | | |
|---|---|---|---|---|---|
| BFL | 11.53 mm | f45 | −44.96 mm | TTL/f | 4.12 |
| TTL/BFL | 3.47 | (R11 + R12)/ | −0.66 | \| f45/f \| | 4.63 |
| | | (R11 − R12) | | | |
| f4/f5 | −0.61 | Vd5 − Vd4 | 25.80 | R32/R31 | −0.35 |

In addition, the lens assembly 4 of the fourth embodiment can meet the requirements of optical performance, wherein the field curvature diagram, the distortion diagram, the spot diagram, and the modulation transfer function diagram are similar to those of the lens assembly 1 of the first embodiment, so that those figures are omitted.

Referring to FIG. 7, the lens assembly 5 includes a first lens L51, a second lens L52, a stop STS, a third lens L53, a fourth lens L54, a fifth lens L55, a sixth lens L56, and a cover glass CGS, all of which are arranged in order from an object side to an image side along an optical axis OAS. In operation, the light from the object side is imaged on an image plane IMA5.

According to paragraphs [0030]-[0037], wherein: the first lens L51 is a biconvex lens, wherein the image side surface S52 is a convex surface; the second lens L52 is a biconcave lens, wherein the object side surface S53 is a concave surface; both of the object side surface S59 and image side surface S510 of the fifth lens L55 are spherical surfaces; the sixth lens L56 is a biconvex lens, wherein the object side surface S511 is a convex surface, and both of the object side surface S511 and image side surface S512 are aspheric surfaces; the fourth lens L54 and the fifth lens L55 are cemented; and both of the object side surface S513 and image side surface S514 of the cover glass CGS are plane surfaces.

With the above design of the lenses, stop ST5, and at least one of the conditions (1)-(7) satisfied, the lens assembly 5 can have an effective shortened total lens length, an effective increased resolution, an effective resisted environmental temperature change, an effective corrected aberration, and an effective corrected chromatic aberration.

Table 13 shows the optical specification of the lens assembly 5 in FIG. 7.

TABLE 13
Effective Focal Length = 9.55 mm
F-number = 2.30 Total Lens
Length = 41.04 mm
Field of View = 61.60 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S51 | 22.53 | 2.691 | 1.81 | 25.5 | 21.87 | L51 |
| S52 | −67.04 | 0.465 | | | | |
| S53 | −34.57 | 2.036 | 1.52 | 64.2 | −7.41 | L52 |
| S54 | 4.33 | 4.794 | | | | |
| S55 | ∞ | 1.079 | | | | ST5 |
| S56 | 28.91 | 3.324 | 1.68 | 55.6 | 9.6 | L53 |
| S57 | −7.85 | 2.863 | | | | |
| S58 | −7.18 | 0.912 | 1.85 | 23.8 | −5.13 | L54 |
| S59 | 10.73 | 5.155 | 1.77 | 49.6 | 8.67 | L55 |
| S510 | −13.50 | 0.092 | | | | |
| S511 | 34.60 | 5.457 | 1.81 | 41 | 14.95 | L56 |
| S512 | −16.65 | 10.531 | | | | |
| S513 | ∞ | 0.550 | 1.52 | 64.1 | | CG5 |
| S514 | ∞ | 1.095 | | | | |

The definition of aspheric surface sag z of each aspheric lens in table 13 is the same as that of in Table 1, and is not described here again.

In the fifth embodiment, the conic constant k and the aspheric coefficients A, B, C, D, E, F, G of each aspheric lens are shown in Table 14.

TABLE 14

| Surface | | A | B | C | |
|---|---|---|---|---|---|
| Number | k | E | F | G | D |
| S511 | 13.2772 | 1.7540E−05 | 1.8735E−06 | −3.1212E−08 | 5.6848E−10 |
| | | −3.5514E−12 | 0 | 0 | |
| S512 | −12.5745 | −1.7202E-04 | 6.8510E−06 | −8.5724E−08 | 8.8793E−10 |
| | | 0 | 0 | 0 | |

Table 15 shows the parameters and condition values for conditions (1)-(7) in accordance with the fifth embodiment of the invention. It can be seen from Table 15 that the lens assembly 5 of the fifth embodiment satisfies the conditions (1)-(7).

TABLE 15

| | | | | | |
|---|---|---|---|---|---|
| BFL | 12.18 mm | f45 | −24.46 mm | TTL/f | 4.30 |
| TTL/BFL | 3.37 | (R11 + R12)/ | −0.50 | \| f45/f \| | 2.56 |
| | | (R11 − R12) | | | |
| f4/f5 | −0.59 | Vd5 − Vd4 | 25.80 | R32/R31 | −0.27 |

In addition, the lens assembly 5 of the fifth embodiment can meet the requirements of optical performance, wherein the field curvature diagram, the distortion diagram, the spot diagram, and the modulation transfer function diagram are similar to those of the lens assembly 1 of the first embodiment, so that those figures are omitted.

Referring to FIG. 8, the lens assembly 6 includes a first lens L61, a second lens L62, a stop ST6, a third lens L63, a fourth lens L64, a fifth lens L65, a sixth lens L66, and a cover glass CG6, all of which are arranged in order from an object side to an image side along an optical axis OA6. In operation, the light from the object side is imaged on an image plane IMA6.

According to paragraphs [0030]-[0037], wherein: the first lens L61 is a biconvex lens, wherein the image side surface S62 is a convex surface; the second lens L62 is a biconcave lens, wherein the object side surface S63 is a concave surface; both of the object side surface S69 and image side surface S610 of the fifth lens L65 are spherical surfaces; the sixth lens L66 is a biconvex lens, wherein the object side surface S611 is a convex surface, and both of the object side surface S611 and image side surface S612 are aspheric surfaces; the fourth lens L64 and the fifth lens L65 are cemented; and both of the object side surface S613 and image side surface S614 of the cover glass CG6 are plane surfaces.

With the above design of the lenses, stop ST6, and at least one of the conditions (1)-(7) satisfied, the lens assembly 6 can have an effective shortened total lens length, an effective increased resolution, an effective resisted environmental temperature change, an effective corrected aberration, and an effective corrected chromatic aberration.

Table 16 shows the optical specification of the lens assembly 6 in FIG. 8.

TABLE 16
Effective Focal Length = 9.94 mm
F-number = 2.30 Total Lens
Length = 44.05 mm
Field of View = 59.97 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S61 | 29.86 | 3.016 | 1.81 | 25.5 | 26.38 | L61 |
| S62 | −63.61 | 0.560 | | | | |
| S63 | −36.39 | 3.065 | 1.52 | 64.2 | −7.95 | L62 |
| S64 | 4.69 | 5.324 | | | | |
| S65 | ∞ | 0.825 | | | | ST6 |
| S66 | 24.94 | 3.930 | 1.68 | 55.6 | 10.03 | L63 |
| S67 | −8.58 | 2.902 | | | | |
| S68 | −7.47 | 0.992 | 1.85 | 23.8 | −5.26 | L64 |
| S69 | 10.79 | 5.449 | 1.77 | 49.6 | 8.54 | L65 |
| S610 | −12.72 | 0.129 | | | | |
| S611 | 32.48 | 5.016 | 1.81 | 41 | 17.35 | L66 |
| S612 | −22.04 | 10.531 | | | | |
| S613 | ∞ | 0.550 | 1.52 | 64.1 | | CG6 |
| S614 | ∞ | 1.758 | | | | |

The definition of aspheric surface sag z of each aspheric lens in table 16 is the same as that of in Table 1, and is not described here again.

In the sixth embodiment, the conic constant k and the aspheric coefficients A, B, C, D, E, F, G of each aspheric lens are shown in Table 17.

TABLE 17

| Surface | | A | B | C | D |
|---|---|---|---|---|---|
| Number | k | E | F | G | |
| S611 | 13.5481 | 1.4825E−05 | 1.5054E−06 | −3.2599E−08 | 7.3026E−10 |
| | | −6.5014E−12 | 0 | 0 | |
| S612 | −6.5756 | 6.9397E−05 | 1.6672E−06 | −5.3686E−09 | 3.1714E−10 |
| | | 0 | 0 | 0 | |

Table 18 shows the parameters and condition values for conditions (1)-(7) in accordance with the sixth embodiment of the invention. It can be seen from Table 18 that the lens assembly 6 of the sixth embodiment satisfies the conditions (1)-(7).

TABLE 18

| | | | | | |
|---|---|---|---|---|---|
| BFL | 12.84 mm | f45 | −32.19 mm | TTL/f | 4.43 |
| TTL/BFL | 3.43 | (R11 + R12)/ | −0.36 | \| f45/f \| | 3.24 |
| | | (R11 − R12) | | | |
| f4/f5 | −0.62 | Vd5 − Vd4 | 25.80 | R32/R31 | −0.34 |

In addition, the lens assembly 6 of the sixth embodiment can meet the requirements of optical performance, wherein the field curvature diagram, the distortion diagram, the spot diagram, and the modulation transfer function diagram are similar to those of the lens assembly 1 of the first embodiment, so that those figures are omitted.

Referring to FIG. 9, the lens assembly 7 includes a first lens L71, a second lens L72, a third lens L73, a stop ST7, a fourth lens L74, a fifth lens L75, a sixth lens L76, a seventh lens L77, an optical filter OF7, and a cover glass CG7, all of which are arranged in order from an object side to an image side along an optical axis OA7. In operation, the light from the object side is imaged on an image plane IMA7.

According to paragraphs [0030]400371, wherein: the first lens L71 is a meniscus lens, wherein the image side surface S72 is a concave surface; the second lens L72 is a meniscus lens, wherein the object side surface S73 is a convex surface; both of the object side surface S710 and image side surface S711 of the fifth lens L75 are spherical surfaces; the sixth lens L76 is a biconvex lens, wherein the object side surface S712 is a convex surface, and both of the object side surface S712 and image side surface S713 are spherical surfaces; the seventh lens L77 is a biconcave lens with negative refractive power and made of glass material, wherein the object side surface S714 is a concave surface, the image side surface is S715 is a concave surface, and both of the object side surface S714 and image side surface S715 are spherical surfaces; both of the object side surface S716 and image side surface S717 of the optical filter OF7 are plane surfaces; and both of the object side surface S718 and image side surface S719 of the cover glass CG7 are plane surfaces.

With the above design of the lenses, stop ST7, and at least one of the conditions (1)-(9) satisfied, the lens assembly 7 can have an effective shortened total lens length, an effective increased resolution, an effective resisted environmental temperature change, an effective corrected aberration, and an effective corrected chromatic aberration.

Table 19 shows the optical specification of the lens assembly 7 in FIG. 9.

TABLE 19
Effective Focal Length = 11.07 mm
F-number = 1.60 Total Lens
Length = 28.00 mm
Field of View = 50.66 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S71 | 9.65 | 2.928 | 2.001 | 29.1347 | 27.1072 | L71 |
| S72 | 12.66 | 0.902 | | | | |
| S73 | 85.55 | 0.492 | 1.50802 | 61.0613 | −11.543 | L72 |
| S74 | 5.49 | 2.187 | | | | |
| S75 | 12.41 | 1.269 | 1.83481 | 42.7215 | 11.5063 | L73 |
| S76 | −41.30 | 0.084 | | | | |
| S77 | ∞ | 1.920 | | | | ST7 |
| S78 | −10.93 | 0.497 | 1.98612 | 16.4839 | −7.2751 | L74 |
| S79 | 22.03 | 0.115 | | | | |
| S710 | 25.69 | 4.757 | 1.90043 | 37.3724 | 8.58858 | L75 |
| S711 | −10.16 | 0.722 | | | | |
| S712 | 15.03 | 5.001 | 1.80401 | 46.5677 | 10.0595 | L76 |
| S713 | −15.03 | 0.914 | | | | |
| S714 | −10.35 | 2.073 | 1.50802 | 61.0613 | −15.022 | L77 |
| S715 | 31.35 | 3.000 | | | | |
| S716 | ∞ | 0.500 | 1.52 | 64.17 | | OF7 |
| S717 | ∞ | 0.138 | | | | |
| S718 | ∞ | 0.40 | 1.52 | 64.17 | | CG7 |
| S719 | ∞ | 0.10 | | | | |

Table 20 shows the parameters and condition values for conditions (1)-(9) in accordance with the seventh embodiment of the invention. It can be seen from Table 20 that the lens assembly 7 of the seventh embodiment satisfies the conditions (1)-(9).

TABLE 20

| BFL | 4.14 mm | f45 | 71.26 mm | | |
|---|---|---|---|---|---|
| TTL/f | 2.53 | TTL/BFL | 6.77 | (R11 + R12)/ | −7.42 |
| | | | | (R11 − R12) | |
| \| f45/f \| | 6.44 | f4/f5 | −0.85 | Vd5 − Vd4 | 20.89 |
| R32/R31 | −3.33 | Vd7/Vd6 | 1.31 | Nd6 − Nd7 | 0.30 |

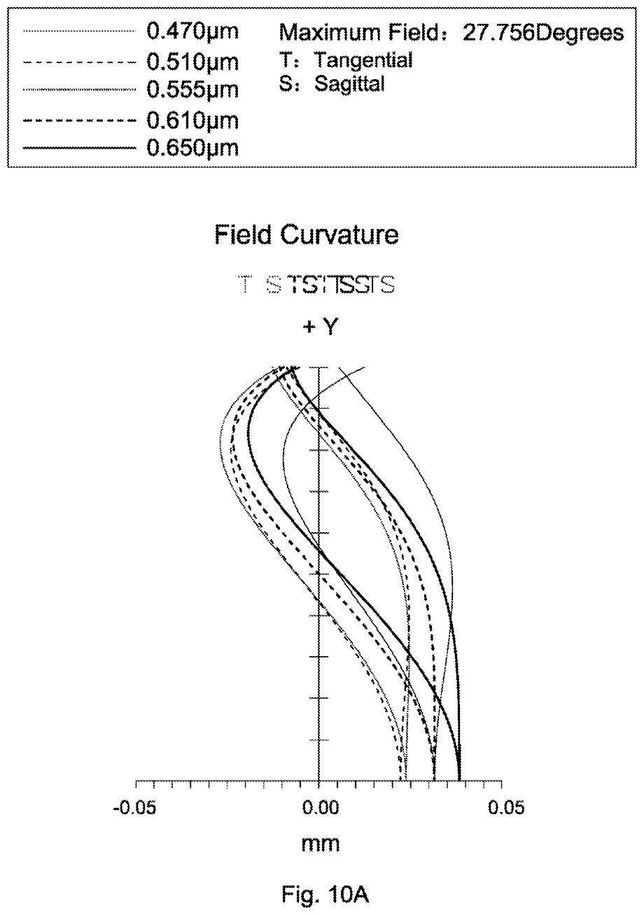

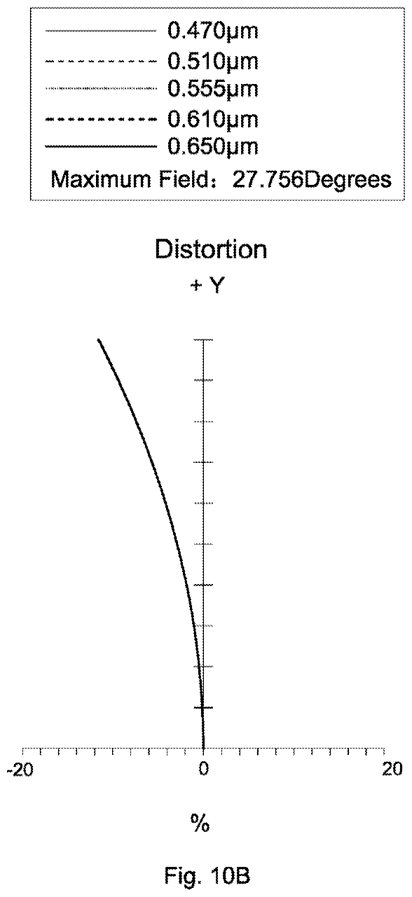

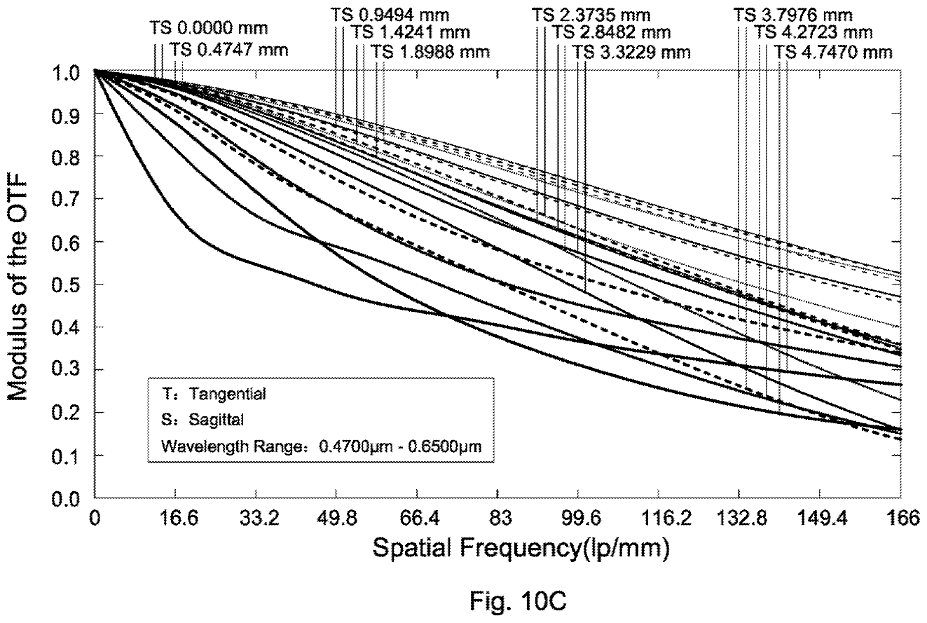

In addition, the lens assembly 7 of the seventh embodiment can meet the requirements of optical performance as seen in FIGS. 10A-10C. It can be seen from FIG. 10A that the field curvature of tangential direction and sagittal direction in the lens assembly 7 of the seventh embodiment ranges from −0.03 mm to 0.04 mm. It can be seen from FIG. 10B that the distortion in the lens assembly 7 of the seventh embodiment ranges from −12% to 0%. It can be seen from FIG. 10C that the modulation transfer function of tangential direction and sagittal direction in the lens assembly 7 of the seventh embodiment ranges from 0.14 to 1.0. It is obvious that the field curvature and the distortion of the lens assembly 7 of the seventh embodiment can be corrected effectively, and the resolution of the lens assembly 7 of the seventh embodiment can meet the requirement. Therefore, the lens assembly 7 of the seventh embodiment is capable of good optical performance.

Referring to FIG. 11, the lens assembly 8 includes a first lens L81, a second lens L82, a third lens L83, a stop ST8, a fourth lens L84, a fifth lens L85, a sixth lens L86, a seventh lens L87, an eighth lens L88, an optical filter OF8, and a cover glass CG8, all of which are arranged in order from an object side to an image side along an optical axis OA8. In operation, the light from the object side is imaged on an image plane IMA8.

According to paragraphs [0030]-[0037], wherein: the first lens L81 is a meniscus lens, wherein the image side surface S82 is a concave surface; the second lens L82 is a biconcave lens, wherein the object side surface S83 is a concave surface; both of the object side surface S810 and image side surface S811 of the fifth lens L85 are aspheric surfaces; the sixth lens L86 is a meniscus lens, wherein the object side surface S812 is a concave surface, and both of the object side surface S812 and image side surface S813 are spherical surfaces; the seventh lens L87 is a biconcave lens with negative refractive power and made of glass material, wherein the object side surface S814 is a concave surface, the image side surface is 5815 is a concave surface, and both of the object side surface S814 and image side surface S815 are spherical surfaces; the eighth lens L88 is a meniscus lens with positive refractive power and made of glass material, wherein the object side surface S816 is a convex surface, the image side surface is 5817 is a concave surface, and both of the object side surface S816 and image side surface S817 are aspheric surfaces; both of the object side surface S818 and image side surface S819 of the optical filter OF8 are plane surfaces; and both of the object side surface S820 and image side surface S821 of the cover glass CG8 are plane surfaces.

With the above design of the lenses, stop ST8, and at least one of the conditions (1)-(9) satisfied, the lens assembly 8 can have an effective shortened total lens length, an effective increased resolution, an effective resisted environmental temperature change, an effective corrected aberration, and an effective corrected chromatic aberration.

Table 21 shows the optical specification of the lens assembly 8 in FIG. 11.

TABLE 21
Effective Focal Length = 10.88 mm
F-number = 1.60 Total Lens
Length = 28.00 mm
Field of View = 55.21 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S81 | 12.00 | 1.719 | 2.051 | 26.942 | 43.809 | L81 |
| S82 | 15.00 | 1.239 | | | | |
| S83 | −31.43 | 0.500 | 1.508 | 61.061 | −10.727 | L82 |
| S84 | 6.65 | 2.195 | | | | |
| S85 | 10.34 | 2.170 | 1.9 | 37.371 | 8.272 | L83 |
| S86 | −24.39 | −0.198 | | | | |
| S87 | ∞ | 2.184 | | | | ST8 |
| S88 | −13.08 | 0.693 | 1.986 | 16.484 | −6.854 | L84 |
| S89 | 14.69 | 0.079 | | | | |
| S810 | 13.45 | 5.419 | 1.855 | 36.871 | 6.988 | L85 |
| S811 | −8.83 | 1.027 | | | | |
| S812 | −41.32 | 2.635 | 1.835 | 42.721 | 14.677 | L86 |
| S813 | −9.76 | 0.705 | | | | |
| S814 | −10.24 | 0.500 | 1.517 | 52.189 | −10.527 | L87 |
| S815 | 11.93 | 0.080 | | | | |
| S816 | 9.29 | 2.070 | 1.771 | 49.403 | 34.809 | L88 |
| S817 | 12.80 | 1.200 | | | | |
| S818 | ∞ | 0.40 | 1.52 | 54.52 | | OF8 |
| S819 | ∞ | 2.45 | | | | |
| S820 | ∞ | 0.50 | 1.52 | 64.17 | | CG8 |
| S821 | ∞ | 0.44 | | | | |

The definition of aspheric surface sag z of each aspheric lens in table 21 is the same as that of in Table 1, and is not described here again.

In the eighth embodiment, the conic constant k and the aspheric coefficients A, B, C, D, E, F, G of each aspheric lens are shown in Table 22.

TABLE 22

| Surface | | A | B | C | |
|---|---|---|---|---|---|
| Number | k | E | F | G | D |
| S810 | −2.168491 | −2.120E−04 | 9.055E−06 | −1.556E−07 | 0 |
| | | 0 | 0 | 0 | |
| S811 | −0.2599208 | 3.094E−04 | −3.575E−07 | 1.753E−07 | 0 |
| | | 0 | 0 | 0 | |
| S816 | −0.1957506 | 8.251E−05 | −5.506E−06 | 3.272E−07 | 0 |
| | | 0 | 0 | 0 | |
| S817 | 3.187865 | −3.115E−04 | −8.736E−06 | 3.968E−07 | 0 |
| | | 0 | 0 | 0 | |

Table 23 shows the parameters and condition values for conditions (1)-(9) in accordance with the eighth embodiment of the invention. It can be seen from Table 23 that the lens assembly 8 of the eighth embodiment satisfies the conditions (1)-(9).

TABLE 23

| BFL | 4.98 mm | f45 | 22.71 mm | | |
|---|---|---|---|---|---|
| TTL/f | 2.57 | TTL/BFL | 5.62 | (R11 + R12)/ | −9.00 |
| | | | | (R11 − R12) | |
| \| f45/f \| | 2.09 | f4/f5 | −0.98 | Vd5 − Vd4 | 20.39 |
| R32/R31 | −2.36 | Vd7/Vd6 | 1.22 | Nd6 − Nd7 | 0.32 |

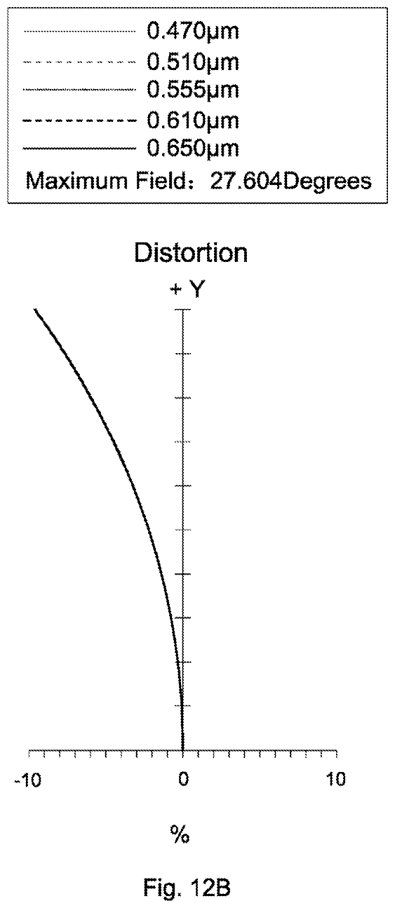

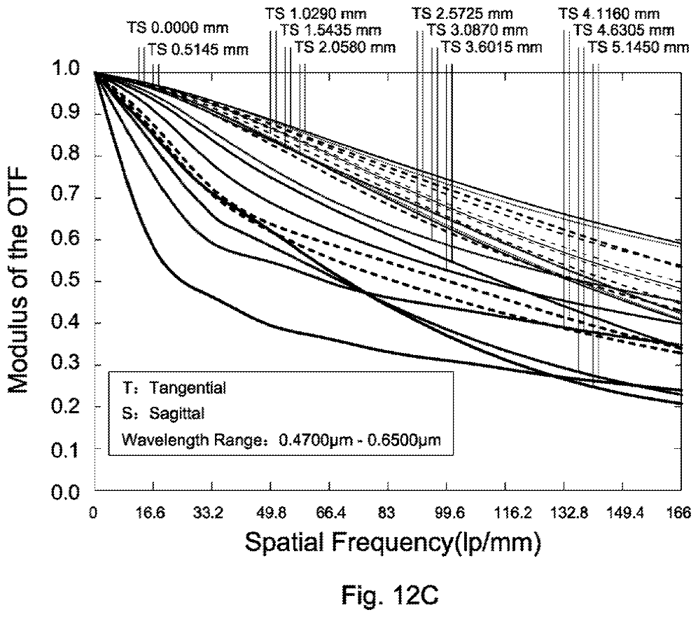

In addition, the lens assembly 8 of the eighth embodiment can meet the requirements of optical performance as seen in FIGS. 12A-12C. It can be seen from FIG. 12A that the field curvature of tangential direction and sagittal direction in the lens assembly 8 of the eighth embodiment ranges from −0.035 mm to 0.035 mm. It can be seen from FIG. 12B that the distortion in the lens assembly 8 of the eighth embodiment ranges from −10% to 0%. It can be seen from FIG. 12C that the modulation transfer function of tangential direction and sagittal direction in the lens assembly 8 of the eighth embodiment ranges from 0.21 to 1.0. It is obvious that the field curvature and the distortion of the lens assembly 8 of the eighth embodiment can be corrected effectively, and the resolution of the lens assembly 8 of the eighth embodiment can meet the requirement. Therefore, the lens assembly 8 of the eighth embodiment is capable of good optical performance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens assembly comprising:
a first lens which is with positive refractive power and comprises a convex surface facing an object side;
a second lens which is with negative refractive power;
a third lens which is a biconvex lens with positive refractive power and comprises a convex surface facing the object side and another convex surface facing an image side;
a fourth lens which is with negative refractive power;
a fifth lens which is with positive refractive power; and
a sixth lens which is with positive refractive power and comprises a convex surface facing the image side;
wherein the first lens, the second lens, the third lens, the fourth lens, the fifth lens, and the sixth lens are arranged in order from the object side to the image side along an optical axis;
wherein the lens assembly satisfies:
2.5<TTL/f<4.75;
wherein TTL is an interval from an object side surface of the first lens to an image plane along the optical axis and f is an effective focal length of the lens assembly.

2. The lens assembly as claimed in claim 1, wherein:
the second lens comprises a concave surface facing the image side;
the fourth lens is a biconcave lens and comprises a concave surface facing the object side and another concave surface facing the image side; and
the fifth lens is a biconvex lens and comprises a convex surface facing the object side and another convex surface facing the image side.

3. The lens assembly as claimed in claim 2, further comprising a seventh lens disposed between the sixth lens and the image side, wherein:
the first lens is a meniscus lens and further comprises a concave surface facing the image side; and
the seventh lens is a biconcave lens with negative refractive power and comprises a concave surface facing the object side and another concave surface facing the image side.

4. The lens assembly as claimed in claim 3, wherein:
the second lens is a meniscus lens and further comprises a convex surface facing the object side; and
the sixth lens is a biconvex lens and further comprises another convex surface facing the object side.

5. The lens assembly as claimed in claim 4, wherein the lens assembly satisfies:
3<TTL/BFL<6.8;
−9.3<(R11+R12)/(R11−R12)<−0.2;
2<|f45/f|<6.5;
−1<f4/f5<0;
20<Vd5−Vd4<40;
−7<R32/R31<−0.2;
wherein TTL is an interval from the object side surface of the first lens to the image plane along the optical axis, BFL is an interval from an image side surface of the lens closest to the image side to the image plane along the optical axis, R11 is a radius of curvature of the object side surface of the first lens, R12 is a radius of curvature of an image side surface of the first lens, f45 is an effective focal length of a combination of the fourth lens and the fifth lens, f is an effective focal length of the lens assembly, f4 is an effective focal length of the fourth lens, f5 is an effective focal length of the fifth lens, Vd4 is an Abbe number of the fourth lens, Vd5 is an Abbe number of the fifth lens, R31 is a radius of curvature of an object side surface of the third lens, and R32 is a radius of curvature of an image side surface of the third lens.

6. The lens assembly as claimed in claim 3, further comprising an eighth lens disposed between the seventh lens and the image side, wherein:
the sixth lens is a meniscus lens and further comprises a concave surface facing the object side; and
the eighth lens is a meniscus lens with positive refractive power and comprises a convex surface facing the object side and a concave surface facing the image side.

7. The lens assembly as claimed in claim 6, wherein the lens assembly satisfies:
3<TTL/BFL<6.8;
−9.3<(R11+R12)/(R11−R12)<−0.2;
2<|f45/f|<6.5;
−1<f4/f5<0;
20<Vd5−Vd4<40;
−7<R32/R31<−0.2;
wherein TTL is an interval from the object side surface of the first lens to the image plane along the optical axis, BFL is an interval from an image side surface of the lens closest to the image side to the image plane along the optical axis, R11 is a radius of curvature of the object side surface of the first lens, R12 is a radius of curvature of an image side surface of the first lens, f45 is an effective focal length of a combination of the fourth lens and the fifth lens, f is an effective focal length of the lens assembly, f4 is an effective focal length of the fourth lens, f5 is an effective focal length of the fifth lens, Vd4 is an Abbe number of the fourth lens, Vd5 is an Abbe number of the fifth lens, R31 is a radius of curvature of an object side surface of the third lens and R32 is a radius of curvature of an image side surface of the third lens.

8. The lens assembly as claimed in claim 3, wherein the lens assembly satisfies: 0.25<Nd6−Nd7<0.33;
wherein Nd6 is an index of refraction of the sixth lens and Nd7 is an index of refraction of the seventh lens.

9. The lens assembly as claimed in claim 8, wherein the lens assembly satisfies:
3<TTL/BFL<6.8;
−9.3<(R11+R12)/(R11−R12)<−0.2;
2<|f45/f|<6.5;
−1<f4/f5<0;
20<Vd5−Vd4<40;
−7<R32/R31<−0.2;
wherein TTL is an interval from the object side surface of the first lens to the image plane along the optical axis, BFL is an interval from an image side surface of the lens closest to the image side to the image plane along the optical axis, R11 is a radius of curvature of the object side surface of the first lens, R12 is a radius of curvature of an image side surface of the first lens, f45 is an effective focal length of a combination of the fourth lens and the fifth lens, f is an effective focal length of the lens assembly, f4 is an effective focal length of the fourth lens, f5 is an effective focal length of the fifth lens, Vd4 is an Abbe number of the fourth lens, Vd5 is an Abbe number of the fifth lens, R31 is a radius of curvature of an object side surface of the third lens and R32 is a radius of curvature of an image side surface of the third lens.

10. The lens assembly as claimed in claim 3, wherein the lens assembly satisfies: 1.0<Vd7/Vd6<1.5;
wherein Vd6 is an Abbe number of the sixth lens and Vd7 is an Abbe number of the seventh lens.

11. The lens assembly as claimed in claim 10, wherein the lens assembly satisfies:
3<TTL/BFL<6.8;
−9.3<(R11+R12)/(R11−R12)<−0.2;
2<|f45/f|<6.5;
−1<f4/f5<0;
20<Vd5−Vd4<40;
−7<R32/R31<−0.2;
wherein TTL is an interval from the object side surface of the first lens to the image plane along the optical axis, BFL is an interval from an image side surface of the lens closest to the image side to the image plane along the optical axis, R11 is a radius of curvature of an object side surface of the first lens, R12 is a radius of curvature of the image side surface of the first lens, f45 is an effective focal length of a combination of the fourth lens and the fifth lens, f is an effective focal length of the lens assembly, f4 is an effective focal length of the fourth lens, f5 is an effective focal length of the fifth lens, Vd4 is an Abbe number of the fourth lens, Vd5 is an Abbe number of the fifth lens, R31 is a radius of curvature of an object side surface of the third lens and R32 is a radius of curvature of an image side surface of the third lens.

12. The lens assembly as claimed in claim 2, wherein:
the first lens is a biconvex lens and further comprises another convex surface facing the image side; and
the sixth lens is a biconvex lens and further comprises another convex surface facing the object side.

13. The lens assembly as claimed in claim 12, wherein:
the fourth lens and the fifth lens are cemented; and
the sixth lens is an aspheric lens.

14. The lens assembly as claimed in claim 13, wherein the lens assembly satisfies:
3<TTL/BFL<6.8;
−9.3<(R11+R12)/(R11−R12)<−0.2;
2<|f45/f|<6.5;
−1<f4/f5<0;
20<Vd5−Vd4<40;
−7<R32/R31<−0.2;
wherein TTL is an interval from the object side surface of the first lens to the image plane along the optical axis, BFL is an interval from an image side surface of the lens closest to the image side to the image plane along the optical axis, R11 is a radius of curvature of the object side surface of the first lens, R12 is a radius of curvature of an image side surface of the first lens, f45 is an effective focal length of a combination of the fourth lens and the fifth lens, f is an effective focal length of the lens assembly, f4 is an effective focal length of the fourth lens, f5 is an effective focal length of the fifth lens, Vd4 is an Abbe number of the fourth lens, Vd5 is an Abbe number of the fifth lens, R31 is a radius of curvature of an object side surface of the third lens and R32 is a radius of curvature of an image side surface of the third lens.

15. The lens assembly as claimed in claim 1, further comprising a stop disposed between the second lens and the fourth lens.

16. The lens assembly as claimed in claim 1, wherein the lens assembly satisfies:
3<TTL/BFL<6.8;
−9.3<(R11+R12)/(R11−R12)<−0.2;
2<|f45/f|<6.5;
−1<f4/f5<0;
20<Vd5−Vd4<40;
−7<R32/R31<−0.2;
wherein TTL is an interval from the object side surface of the first lens to the image plane along the optical axis, BFL is an interval from an image side surface of the lens closest to the image side to the image plane along the optical axis, R11 is a radius of curvature of the object side surface of the first lens, R12 is a radius of curvature of an image side surface of the first lens, f45 is an effective focal length of a combination of the fourth lens and the fifth lens, f is an effective focal length of the lens assembly, f4 is an effective focal length of the fourth lens, f5 is an effective focal length of the fifth lens, Vd4 is an Abbe number of the fourth lens, Vd5 is an Abbe number of the fifth lens, R31 is a radius of curvature of an object side surface of the third lens and R32 is a radius of curvature of an image side surface of the third lens.
